(19) United States
(12) Patent Application Publication
(10) Pub. No.: US 2004/0205518 A1
(43) Pub. Date: Oct. 14, 2004

(54) System and method of measuring a distance between two points of a layout

(76) Inventor: Ming-Chih Shih, HsinChu City (TW)

Correspondence Address: BIRCH STEWART KOLASCH & BIRCH, PO BOX 747, FALLS CHURCH, VA, 22040-0747, US

(21) Appl. No.: 09/957,185

(22) Filed: Sep. 21, 2001

(51) Int. Cl. G06F 17/24

(52) U.S. Cl. 715/502; 715/517

(57) ABSTRACT

A method of measuring a distance between two points of a layout, which first generates a first view and a second view of the layout, and maintains a transformation relationship between the first view and the second view. Then, after accepting a first point on the first view, trace a cursor's position on the second view as the second point, and graphically displays the distance between the first point and the second point on the first view and the second view. The first point is transformed according to the transformation relationship to determine its position in the second view, and the second point is transformed according to the transformation relationship to determine its position in the first view.

### BACKGROUND OF THE INVENTION

1. Field of the Invention

The invention relates to a system and method of measuring a distance between two points of a layout, which can display the distance on different views simultaneously and dynamically to facilitate the operation of a user.

2. Related Art

Along with the fast development in computer technology, the IC-related layout, for example, the circuit layout of a VLSI, the mask pattern layout of a VLSI or the PCB (printed circuit board) layout has becomes more and more huge and complicated. Therefore, it has become very difficult for users to design IC-related layouts by hand. Users always use a CAD system with various design tools or functions to design a complex layout.

In a conventional CAD system, if a user wants to inspect a specific portion of a huge and complex layout, he/she may first open a new window for this portion, then perform a zoom-in action to view the wires, elements or devices in the portion more clearly. However, if a user wants to inspect a relationship between two or more positions, the conventional CAD system can not dynamically display the relationship between the different positions across different windows.

For example, if a user wants to measure a distance between two points in a layout, he/she must first select a start point and then select an end point. To correctly select the start point, the user must perform a zoom-in action to inspect a portion near the start point more clearly.

However, after selecting the start point, the user must perform a pan function under the current window to move the window to a portion near the end point to accurately select the end point. In other words, even when the user opens two windows to inspect the start point and the end point respectively, he/she still must finish the measuring operation under a same window. This kind of operation is very inconvenient for users to design a layout.

### SUMMARY OF THE INVENTION

In view of the above, an objective of the invention is to provide a system and method of inspecting a specific relationship between two points in different views, which can display a distance on different views simultaneously and dynamically to facilitate the operation of a user.

To achieve the above objective, the method of measuring a distance between two points of a layout first generates a first view and a second view of the layout, and maintains a transformation relationship between the first view and the second view. Then, after accepting a first point on the first view, trace a cursor's position on the second view as the second point, and graphically displays the distance between the first point and the second point on the first view and the second view. The first point is transformed according to the transformation relationship to determine its position in the second view, and the second point is transformed according to the transformation relationship to determine its position in the first view.

According to an embodiment to the invention, the first view has a first relationship with original data of the layout, and the second view has a second relationship with the original data of the layout. The transformation relationship between the first view and the second view is established according to the first relationship and the second relationship.

The invention also provides a system of displaying a distance between two points of a layout, including a user interface and a view generator. The view generator generates a first view and a second view of the layout, wherein the second view has a transformation relationship with the first view. The user interface accepts a first point on the first view, and traces a cursor's position on the second view as the second point. The view generator graphically displays the distance between the first point and the second point on the first view and on the second view. The second point is transformed according to the transformation relationship to determine its position in the first view, and the first point is transformed according to the transformation relationship to determine its position in the second view.

According to the invention, the distance between two points in different views can be dynamically and simultaneously displayed in different views. Thus, it facilitates the operation of the user to inspect the relationship between two points in different views.

Further scope of the applicability of the invention will become apparent from the detailed description given hereinafter. However, it should be understood that the detailed description and the specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a block diagram showing an operating environment for a preferred embodiment of the invention;

FIG. 2 is a schematic diagram showing functional blocks of a preferred embodiment of the invention;

FIG. 3 is a screen shot showing a first view and a second view generated by a view generator according to a preferred embodiment of the invention;

FIG. 4 is a flow chart showing the procedure of the distance-measuring operation according to the preferred embodiment of the invention;

FIG. 5 is a screen shot showing the condition of the cursor being in the first view after the first point being selected; and

FIG. 6 is a screen shot showing the condition of the cursor being in the second view after the first point being selected.

### DETAILED DESCRIPTION OF THE PREFERRED EMBODIMENT

The invention will be apparent from the following detailed description of the preferred embodiment, which proceeds with reference to the accompanying drawings, wherein the same references relate to the same elements.

FIG. 1 is a block diagram illustrating a computer 10 that serves as an operating environment for the preferred embodiment of the invention. Referring to FIG. 1, the computer 10 includes at least one input device 11 having a cursor control device, and at least one output device 12 having a display. The computer 10 also has at least one high-speed central processing unit (CPU) 13 and a memory 14. The input device, the output device, the memory and CPU are interconnected and communicate through at least one bus structure.

The input device 11 and output device 12 may be conventional peripheral devices coupled to or installed within the computer. For instance, the input device 11 may comprise a cursor control device such as a mouse. The output device 12 may be a conventional display monitor such as a conventional CRT display monitor or an LCD display monitor.

The CPU 13 may be a conventional design including an ALU 131 for performing computations, registers 132 for temporary storage of data and instructions, and a control unit 133 for controlling operation of the computer 10. The memory 14 may includes high-speed memory device 141 in the form of a random access memory (RAM) or read only memory (ROM) semiconductor devices, and storage device 142 in the form of floppy disks, hard disks, or CD-ROMs. The memory 14 can comprise a variety of alternative components having a variety of storage capacities.

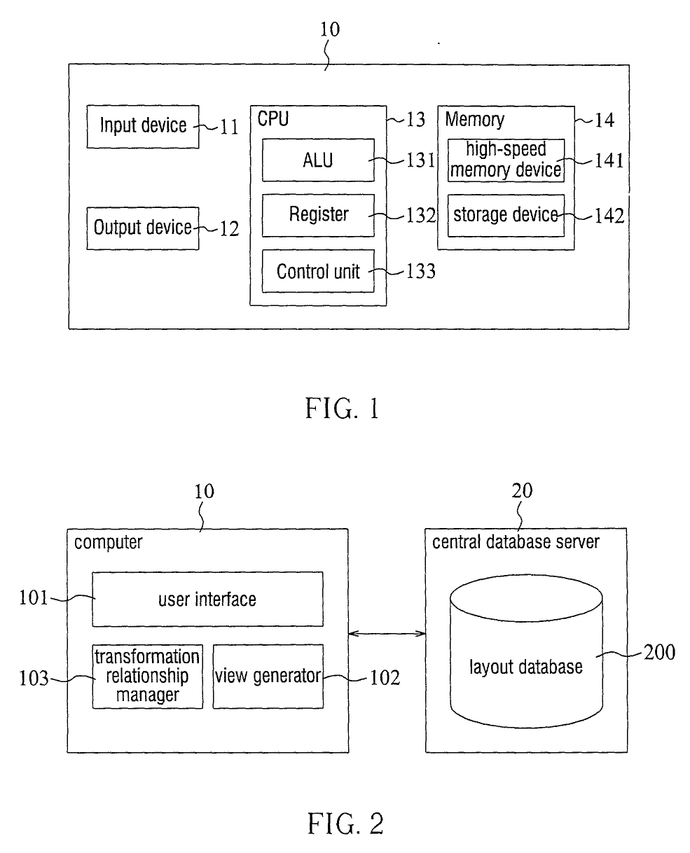

FIG. 2 is a schematic diagram showing functional blocks of a preferred embodiment of the invention. The computer 10 mentioned above is installed with a user interface 101, a view generator 102 and a transformation relationship manager 103.

The user interface 101, the view generator 102 and the transformation relationship manager 103 may be software modules. However, it should be noted that one skilled in the art might design specific circuits for the same functions to enhance the efficiency of the CAD system.

The geometry and the topology data of the layout are stored in a layout database 200. The layout database 200 may be stored in the memory 14 or in another computer. In the preferred embodiment, the layout database is stored in a central database server 20, and the computer 10 is connected with a central database server 20 via a packet-switching communication network. While the user is viewing or editing the layout, a part of the geometry data or image data of the layout can be transmitted from the central database server and stored temporarily in the memory 14 of the computer 10 for data representation. Upon receiving the instructions, the instructions can be sent to the central database server for execution, or be processed at the client side, i.e., at the computer 10.

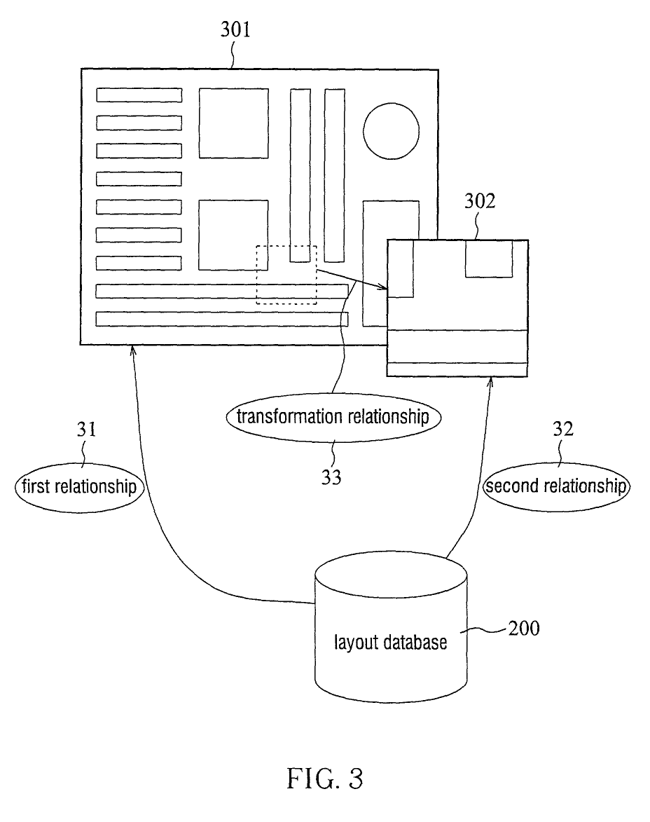

Referring to FIG. 3, the view generator 102 generates a first view 31 and a second view 32 on the display of the computer 10. The second view 32 is an enlarged view of the area surrounded by the dotted line in the first view 31.

The relationship between the first view 301 and the original data of the layout stored in the layout database 200 is a first relationship 31, and the relationship between the second view 302 and the data of the layout stored in the layout database is a second relationship 32. The transformation relationship manager 103 manages the transformation relationship 33 between the first view 301 and the second view 302 by performing operations to the first relationship 31 and the second relationship 32. In the preferred embodiment, the first relationship 31, the second relationship 32 and the transformation relationship 33 are in forms of linear transformation matrices. One can multiply the position vector of a specific point in the original data of the layout with the matrix of the first relationship 31 or the second relationship 32 to obtain the position vector of the point on the display with respect to the coordinate system of the first view 301 or the second view 32. To obtain the transformation relationship 33, the transformation relationship manager 103 performs operations to the matrices of the first relationship 31 and the second relationship 32.

The user interface 101 accepts point-selecting actions, instructions or requests input by the user. For example, the user can select a function from a drop-down menu, or select an entity in the first view or the second view shown on the display by clicking a button of a mouse. Once accepts a user's input, an appropriate functional module handles the input. Then, the view generator 102 outputs the result to the first view 301 or the second view 302 or both. If the transformation relationship 33 is changed (for example, the user performs a zoom-in action or a pan-move action to the first view 301), the transformation relationship manager 103 then modifies the transformation relationship 33 according to the user's input.

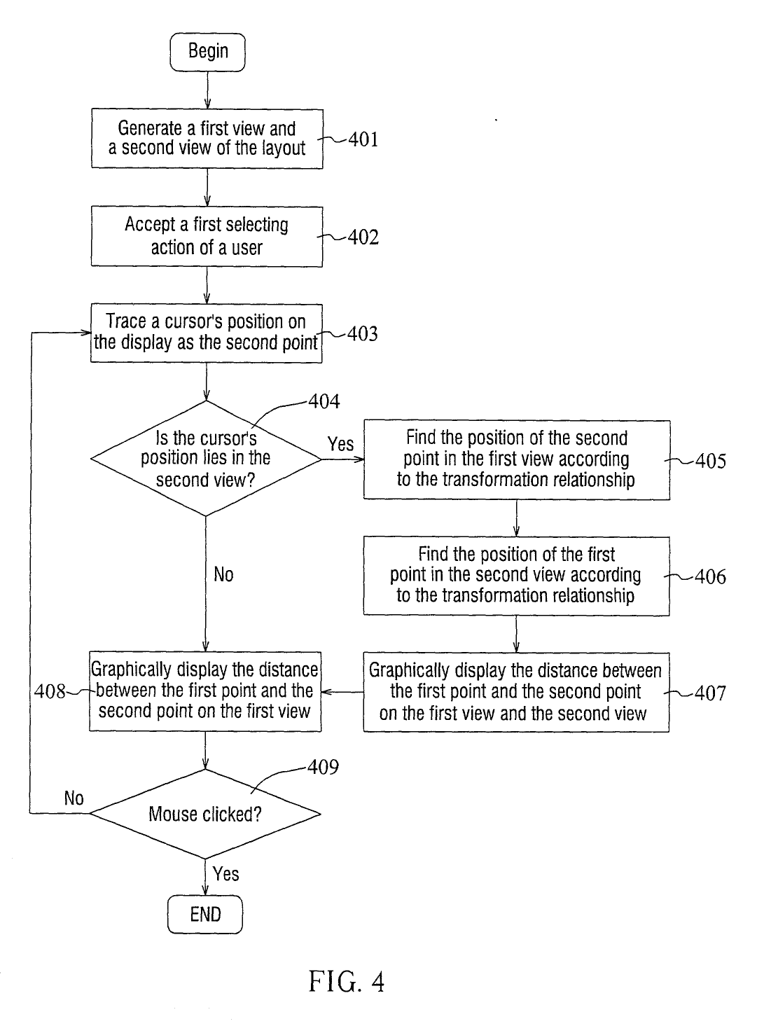

The detailed procedures of the distance-measuring operation will be described hereinbelow with reference to FIG. 4.

Referring to FIG. 4, the view generator firstly generates the first view 301 and the second view 302 of the layout in step 401. In the preferred embodiment, the second view 302 is an enlarged view of a region (the region surrounded by dotted line in FIG. 3) in the view 301.

Then, the user interface 101 accepts a first selecting action in step 402. In the preferred embodiment, the user selects a first point in the first view 31 by clicking a button of a mouse. The user interface 101 receives the mouse-button-clicked event, and retrieves the coordinate of the mouse-clicked position on the display screen. The coordinate is then transformed into the coordinate with respect to the coordinate system of the geometry data of the layout according to the first relationship 31.

After accepting the first point in the first view 301, the user interface 101 traces the cursors coordinate on the display as the second point in step 403. Then the step 404 judges if the position of the cursor lies in the second view 302. If the cursor is in the first view 301 and not in the second view 302, then the view generator 102 graphically displays the distance between the first point and the second point in the first view 301 (step 408). The coordinate of the second point is transformed into the coordinate with respect to the coordinate system of the geometry data of the layout according to the first relationship 31.

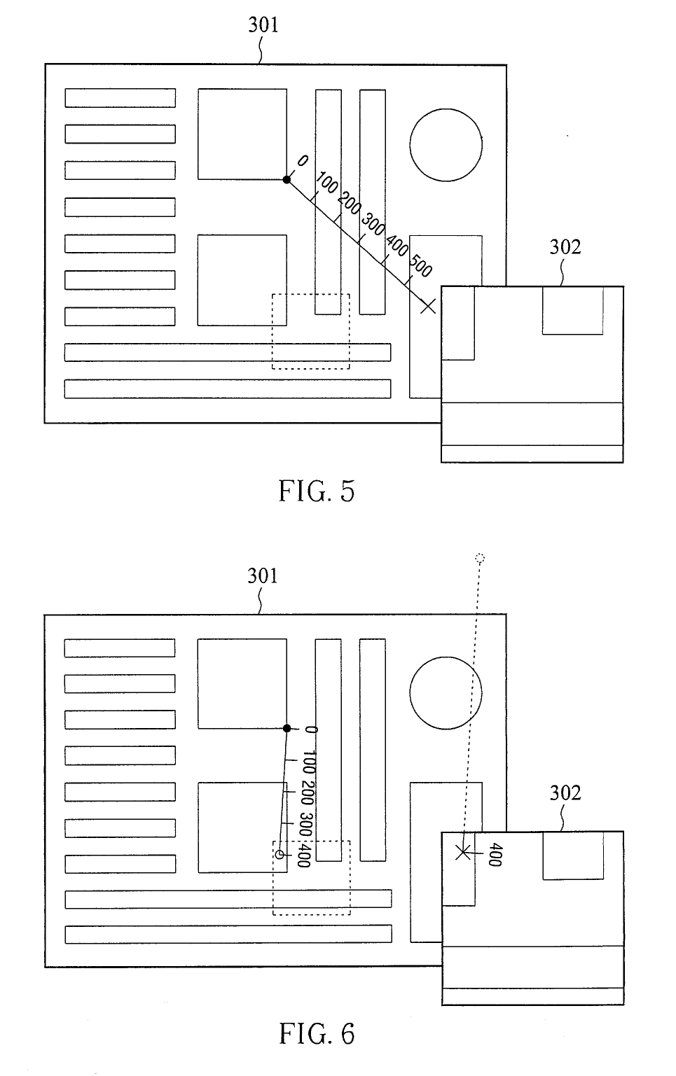

Referring to FIG. 5, in the preferred embodiment, to display the distance “graphically” means to draw a ruler-like line between the first point and the second point to indicate the distance between them. In FIG. 5, the first point is represented by a solid dot, and the second point (the cursor) is represented by an “X” symbol. The ruler-like line between the solid dot and the “X” symbol represents the distance between them. Please note that various alternatives can be used to represent the distance between the first point and the second point. For example, one can just draws a line between the first point and the second, and shows the distance by displaying the value of the distance directly on the screen.

Referring back to FIG. 4, if the cursor's position lies in the second view 302, then the view generator shows the distance between the first point and the second point on both the first view 301 and the second view 302 at the same time. This is accomplished by finding the position of the second point in the first view 301 and the position of the first point in the second view 302 according to the transformation relationship (step 405 and 406), and graphically displaying the distance between the first point and the second point on the first view 301 and the second view 302 (step 407).

Referring to FIG. 6, when the cursor, i.e., the “X” symbol, is moved into the second view 302, the view generator 102 calculates the position of the second point on the first view 301 according to the transformation relationship 33 maintained by the transformation relationship manager 103. The view generator 102 also calculates the position of the first point on the second view 302 according to the transformation relationship 33. Since the position of the first point in the second view 302 (represented as a dotted circle in FIG. 6) is out of the boundary of the second view 302, the position of the first point in the second view 302 is not displayed on the display screen.

As shown in FIG. 6, in the preferred embodiment, a small hollow circle is used to represent the second point in the first view 301, and the ruler-like line appears both in the first view 301 and in the second view 302. As the user moves the cursor in the second view 302, the hollow circle and the ruler-like line in the first view 301 moves accordingly. Therefore, the user can see the distance measuring state in the first view 301 and in the second view 302 simultaneously.

The interface keeps tracing the position of the cursor on the display until the user performs a second selecting action, i.e., clicks the button of the mouse in step 409. In other words, after the mouse-clicking action, the user interface 101 does not trace the position of the cursor, leaves the last distance-measuring result on the screen.

It should be note that while the user interface 101 tracing the position of the cursor on the screen, it is the view generator 102 which handles what to display in the first view 301 and in the second view 302. If there is anything that should be shown in the first view and the second view simultaneously, it is the view generator 102 that generates the result with reference to the transformation relationship 33. In other words, since the position of the cursor is handled by the view generator 102 independent of which view the cursor is in, and the view generator 102 judges what to display in each view, the distance between points will be shown in each view correctly even though there are more than three views on the display at the same time.

Furthermore, since the computer 10 can handle the whole distance-measuring operation according to the preferred embodiment of the invention, the network connecting the computer 10 and the central database server 20 will not delay the distance-measuring operation. Therefore, the method according to the preferred embodiment of the invention is suitable for implementing in CAD systems operating under network environments.

Moreover, the distance-measuring operation according to the preferred embodiment of the invention can dynamically display the relationship of the different positions across different views. Thus, it facilitates the operation of the user to inspect the relationship between two points in different views. For example, when measuring the distance between two remotely located points, the user can open two views, select the first point in the first view, and move the cursor into the second view. The view generator will dynamically show the distance between two points in two views simultaneously, which helps the user to understand the state of distance measuring.

While the invention has been described with reference to a preferred embodiment, this description is not intended to be construed in a limiting sense. Various modifications of the embodiment will be apparent to persons skilled in the art upon reference to the description. It is therefore intended that the appended claims encompass any such modifications.

What is claimed is:

1. A method of measuring a distance between a first point and a second point of a layout, comprising:
generating a first view and a second view of the layout, the second view having a transformation relationship with the first view;
accepting a first selecting action of a user to select the first point on the first view;
tracing a position of a cursor on the second view as the position of the second point; and
graphically displaying the distance between the first point and the second point on the first view and the second view,
wherein the first point is transformed according to the transformation relationship to determine its position in the second view, and the second point is transformed according to the transformation relationship to determine its position in the first view.

2. The method according to claim 1, wherein the first selecting action is a click of a button of a mouse.

3. The method according to claim 1, further comprising:
accepting a second selecting action of the user to select the second point on the second view.

4. The method according to claim 3, wherein the second selecting action is a click of a button of a mouse.

5. The method according to claim 1, further comprising:
while tracing the position of the cursor on the display, determining whether the position is in the first view or in the second view.

6. The method according to claim 1, wherein
the first view has a first relationship with original data of the layout;
the second view has a second relationship with the original data of the layout; and
the transformation relationship between the first view and the second view is established according to the first relationship and the second relationship.

7. A system of displaying a distance between a first point and a second point of a layout, comprising:
a view generator for generating a first view and a second view of the layout, the second view having a transformation relationship with the first view; and
a user interface for accepting a first selecting action of the user to select the first point on the first view, and for tracing a cursor's position on the second view as the second point,
wherein the view generator graphically displays the distance between the first point and the second point on the first view and on the second view, the second point is transformed according to the transformation relationship to determine its position in the first view, and the first point is transformed according to the transformation relationship to determine its position in the second view.

8. The system according to claim 7, wherein the first selecting action is a click of a button of a mouse.

9. The system according to claim 7, wherein the user interface further accepting a second selecting action of the user to select the second point on the second view.

10. The system according to claim 9, wherein the second selecting action is a click of a button of a mouse.

11. The system according to claim 7, further comprising:
a transformation relationship manager for maintaining the transformation relationship between the first view and the second view.

12. The system according to claim 11, wherein the transformation relationship manager maintains the transformation relationship by performing a operation to a first relationship and a second relationship, wherein the first relationship is the relationship between the first view and data of the layout, and the second relationship is the relationship between the second view and data of the layout.

13. A computer-readable storage medium storing a plurality of program code for a computer to execute the following procedures:
generating a first view and a second view of the layout, the second view having a transformation relationship with the first view;
accepting a first selecting action of a user to select the first point on the first view;
tracing a position of a cursor on the second view as the position of the second point; and
graphically displaying the distance between the first point and the second point on the first view and the second view,
wherein the first point is transformed according to the transformation relationship to determine its position in the second view, and the second point is transformed according to the transformation relationship to determine its position in the first view.

14. The computer-readable storage medium according to claim 13, wherein the first selecting action is a click of a button of a mouse.

15. The computer-readable storage medium according to claim 13, wherein the procedures further comprises:
accepting a second selecting action of the user to select the second point on the second view.

16. The computer-readable storage medium according to claim 15, wherein the second selecting action is a click of a button a mouse.

17. The computer-readable storage medium according to claim 13, wherein the procedures further comprises:
while tracing the position of the cursor on the display, determining whether it be in the first view or in the second view.

18. The computer-readable storage medium according to claim 13, wherein
the first view has a first relationship with original data of the layout;
the second view has a second relationship with the original data of the layout; and
the transformation relationship between the first view and the second view is established according to the first relationship and the second relationship.
